(19) United States
(12) Patent Application Publication
(10) Pub. No.: US 2017/0317521 A1
(43) Pub. Date: Nov. 2, 2017

(54) METHODS FOR OPERATING A SEPARATE POWER SUPPLY SYSTEM

(71) Applicant: WOBBEN PROPERTIES GMBH, Aurich (DE)

(72) Inventors: Jörg ANDERLOHR, Jever (DE); Kai BUSKER, Großefehn (DE); Bettina LENZ, Oldenburg (DE); Alfred BEEKMANN, Wiesmoor (DE)

(21) Appl. No.: 15/520,803

(22) PCT Filed: Oct. 20, 2015
(86) PCT No.: PCT/EP2015/074233

§ 371 Date: Apr. 20, 2017

(30) Foreign Application Priority Data
Oct. 23, 2014 (DE) 102014221555.2

(51) Int. Cl. H02J 7/34; H02J 3/46; H02J 3/38; H02J 7/00; H02J 3/32

(52) U.S. Cl. CPC H02J 7/34; H02J 7/0021; H02J 3/32; H02J 3/386; H02J 3/46

(57) ABSTRACT

A method for operating an electrical charging station at an electrical grid comprising, alongside electrical loads, at least one regenerative energy generator, at least one conventional generator operated by fossil fuels, and at least the electrical charging station for storing and re-emitting electrical power, wherein the charging station is controlled in such a way that the feed-in power is limited in terms of its change over time.

### BACKGROUND

### Technical Field

The present invention relates to a method for operating an electrical grid, in particular island grid, and the operation of at least one wind energy installation connected thereto and of a charging station connected to the grid. The present invention additionally relates to such a grid, a corresponding charging station and a corresponding wind energy installation, and a wind farm comprising such wind energy installations that is connected to the grid.

### Description of the Related Art

An electrical island grid should be understood to mean in this respect an electrical grid which is separate from a large grid such as the European interconnected grid, for example, and operates autonomously. Such an island grid is usually actually situated on islands or island groups in the geographical sense. However, it can also be an isolated, autonomously operating grid, particularly in a remote region.

The operation of island grids is known and is described e.g., in the two U.S. patent application Ser. No. 10/380,786, which published as US 2005/0225090, and U.S. Ser. No. 10/506,944, which published as US 2005/0200133, which describe, in particular, providing as much energy as possible from wind energy installations for an island grid. If said wind energy installations do not supply enough energy, energy is supplemented from energy stores, and if even that does not suffice, a diesel generator can be supplementarily connected.

What may be disadvantageous here is that primary consumption of the energy of a battery shortens, sometimes significantly shortens, the lifetime of said battery. Besides the costs that would then arise for exchanging a battery, it is also undesirable, precisely in the case of island grids, to have to carry out unnecessary maintenance or repair measures. That is inexpedient particularly if the operation of the island grid is thereby jeopardized at times.

Strictly demand-dependent operation of a diesel generator can also constitute inexpedient loading for the latter which in the long run can also shorten its expected life or maintenance cycles. An additional factor is that diesel generators frequently operate not only with particularly little wear but also particularly economically with a specific rotational speed. In other words, it is advantageous for the diesel generator, too, if the properties thereof are concomitantly taken into account during the operation of an island grid.

### BRIEF SUMMARY

Provided is a battery and a diesel generator in an island grid that are operated with the greatest possible care. At the very least, the intention is to propose an alternative solution to previous solutions.

Provided is a method for operating an electrical charging station at an electrical grid, in particular an island grid, comprising, alongside electrical loads, at least one regenerative generator, in particular a wind energy installation or a wind farm, at least one generator operated by fossil fuels, in particular diesel generator, and at least the electrical charging station for storing and re-emitting electrical power, the method comprising the following steps:

generating electrical power by means of the at least one wind energy installation and feeding the electrical power into the island grid,

storing electrical power not consumed by the loads in the charging station,

feeding in electrical power by means of the charging station if the loads consume more power than is fed into the grid jointly by the at least one regenerative generator and the at least one conventional generator, wherein
in a first configuration of the grid, a feed-in power fed into the grid is a sum of
the power of the at least one regenerative energy generator and
the power of the charging station and optionally in addition
the power of the at least one further generator assigned to the charging station, or
in a second configuration of the grid, the feed-in power fed into the grid is the power generated by the at least one conventional generator,

and wherein the charging station is controlled in such a way that the feed-in power is limited in terms of its change over time.

In this respect, the charging station is a system comprising one or a plurality of batteries that can be charged and discharged. The charging and discharging thus take place via the connection to the electrical island grid. The battery can therefore be charged in the case of a power surplus in the grid and discharged in the opposite case, in order thereby to feed power into the grid. In this case, discharging also describes a process in which the battery is discharged only partly and, if appropriate, also only to the extent of a small portion. The electrical island grid is referred to here for simplification simply as grid. Such island grids are also operated as AC voltage grids and the charging station is correspondingly also prepared to feed an electrical AC current into the grid. The invention is provided particularly for an island grid, but in principle can also be employed in a different electrical supply grid.

By means of the at least one regenerative generator, in particular of a wind energy installation or of a wind farm, electrical power is generated from regenerative energy sources and fed into the island grid, which is mentioned here in a manner representative of other grids as well. In this case, the generation of electrical power denotes for simplification the conversion of mechanical or other power, e.g., solar energy, into electrical power. Correspondingly, here mechanical or other energy is converted into electrical energy. When electrical power is stored, instantaneous power is drawn from the grid by the charging station and is stored in the charging station, in particular in batteries, such that energy is stored as a result.

For feeding regenerative energy into the island grid, at least one wind farm comprising a plurality of wind energy installations is preferably provided here. As an exception, if the island grid is correspondingly small or the wind energy installation is correspondingly large, e.g., the use of just a single wind energy installation could also be sufficient.

Furthermore, a diesel generator is present, which here is also representative of other possible generators that are operated by fossil fuels. These might be, e.g., a generator operated with oil or gas. Any subsequent explanations, unless expressly explained otherwise, which are made concerning a diesel generator also apply in principle to other possible generators that are operated or driven by fossil fuels.

The charging station and thus the batteries present there are operated with the greatest possible care or at least with more care than heretofore and in this context to carry out feeding into the grid as continuously as possible. For this purpose, especially the state of charge of the relevant batteries should be taken into account. In principle, it is inexpedient if such batteries are completely discharged, that is to say that especially a so-called deep discharge should be avoided. Complete charging of a battery to 100 percent can also be inexpedient. An additional factor is that extreme states of charge, that is to say almost complete charging or almost complete discharging, restrict the handleability of the charging station. By way of example, an almost completely discharged charging station cannot provide power for regulating the feeding-in.

Provided is for the charging or discharging of the charging station, that is to say ultimately the battery or a plurality of batteries of the charging station, predefining maximum gradients, namely limiting gradients, which can also be referred to illustratively as maximum edges.

Therefore, an edge is predefined with which the power fed into the grid by the charging station is intended to maximally increase. That is also referred to here as a rise limiting gradient. In addition, a value is predefined with which that power which is drawn from the grid by the charging station and with which the batteries are then charged is intended maximally to increase. In other words, therefore, the dynamic range of the change is predefined here. Surprisingly, this has now also made it possible to influence the absolute charging level of the charging station or of the batteries thereof, which is also referred to here as the state of charge. Appropriate selection of these two maximum values makes it possible to achieve for a longer period of time a situation in which the charging level tends rather to vary upwards or tends rather to vary downwards, or to a mean value. The charging level can thereby be controlled to an upper limit, to a lower limit or to a different range.

Such upper and lower limits can be predefined in order to prevent complete full charging of the battery or complete discharging of the battery. If the charging level tends toward the lower limit, for example, what can be achieved by a decrease of the gradient for the feeding-in of electrical power by means of the charging station is that the charging level no longer tends toward said lower limit or tends toward the latter to a lesser extent. That can therefore be achieved by a flattening of the maximum edge for feeding electrical power into the grid by means of the charging station.

It is thereby possible to regulate the charging station in such a way that the state of charge remains between these two predefined limit values, without the state of charge being evaluated directly for control purposes. Of course, it is also possible to provide a safety interrogation that prevents the lower charging level limit value from being undershot or the upper charging level limit value from being exceeded. However, this should be an exceptional emergency measure and the constant regulation can rather dispense therewith and guide the charging level within the desired limits during normal operation of the island grid, without in this case directly monitoring these limits each time.

In this case, the proposed method can be used in principle for two configurations. In the case of the first configuration, the feed-in power is composed of the power of the at least one regenerative generator and the power of the charging station. These regenerative generators and the charging station are combined in this respect. By way of example, the charging station can be part of a wind farm comprising a plurality of wind energy installations. If the wind power, to stay with this example, fluctuates to an excessively great extent, the charging station can take corresponding countermeasures. The feed-in power that is fed in can be constituted from the power of said wind energy installations and the charging station. Therefore, if the wind power falls to a great extent, the sum of the feed-in power can comply with the desired predefined limit of the change by means of a corresponding rise in the emitted power of the charging station.

As a result, this combination of the regenerative generators and the charging station then jointly feeds a power limited in terms of its change into the grid. In this case, especially the grid perceives this combined feed-in power as exhibiting little fluctuation and accordingly need not compensate for an excessively great fluctuation.

Such a combination of regenerative generator and the charging station, that is to say, e.g., wind farm with charging station, can also be supplemented by a conventional or other further generator. Such a generator would then be assigned to said charging station. That means, in particular, that the power of the corresponding regenerative energy generators, the power of the charging station and the power of said additional generator feed into the grid jointly via a common grid connection point.

In another configuration, the power fed into the grid by at least one conventional generator is regarded as feed-in power and its changes are kept small. This feed-in power of the at least one conventional generator is taken into consideration in the case of this configuration. The conventional generator can run permanently stably and uniformly, in principle. Fluctuations in its feed-in power occur, however, if it, e.g., as a diesel generator or gas-fired power plant, counteracts fluctuations in the grid. The consideration of an island grid is taken as a basis especially here, although this is not restrictive here either. If, e.g., the loads of the grid jointly tap off more power than a moment ago, the conventional generator takes countermeasures and increases its feed-in power in order to compensate for this increased consumption.

The charging station is then used for this case, said charging station feeding so much power into the grid that it compensates for at least a portion of these power fluctuations in the grid. As a result, the at least one conventional generator can then be operated with little change.

As a result, especially said at least one conventional generator is subjected to less loading. In this case, such a conventional generator is also representative of such generator stations which comprise a plurality of such generators. A great rise in the power to be fed in, that is to say in the feed-in power, regularly has the effect that a further generator is supplementarily connected in such a generator station. In the case of a corresponding fall in the power to be emitted, at least one generator is correspondingly disconnected. Especially such excessively frequent supplementary connection and disconnection of conventional generators is avoided particularly for this second configuration.

At all events, however, the load-relieving action by the charging station is carried out in such a way that the feed-in power is limited in terms of its change over time, that is to say does not rise to an excessively great extent and does not fall to an excessively great extent either.

Preferably, for limiting said change over time of the feed-in power, at least one limiting gradient is predefined. The latter can be a rise limiting gradient, which determines with what change per time the feed-in power is intended maximally to increase. As second limiting gradient, a decrease limiting gradient is proposed, which determines with what change per time the feed-in power is intended maximally to decrease. Depending on the application, it is also envisaged that only one of these two limiting gradients is predefined, but it is preferred for both of said limiting gradients to be predefined.

As a result, the limiting of the power change can be controlled and, at the same time, the selection of these limiting gradients also affords the possibility of influencing this contribution providing support by the charging station. In particular, the selection of the limiting gradients can influence the profile of the state of charge of the charging station.

Preferably, the rise limiting gradient and the decrease limiting gradient differ from one another. It is thereby also possible, inter alia, to influence the mean state of charge of the charging station that is established over the course of time. In this context, over the course of time denotes especially the time segment of a day.

In accordance with one embodiment, the charging station is controlled in such a way that the change of the feed-in power is guided within the rise limiting gradient and the decrease limiting gradient and that the change of the feed-in power is positive if the charging station has a state of charge that is above a predefined target state of charge, or that the change of the feed-in power is negative if the charging station has a state of charge that is below a predefined target state of charge. The decrease limiting gradient is a negative value here, of course, in this respect. Illustratively, therefore, the rise limiting gradient predefines a rising edge and the decrease limiting gradient predefines a falling edge as limit. The change of the feed-in power is thus kept within a positive and negative limit.

While the feed-in power is kept or guided within these two limits, the charging station still has latitude in the concrete guidance. It is proposed here, then, that it utilizes this latitude in such a way that the change of the feed-in power is rather positive if the charging station is charged well, to put it simply. In this situation, the charging station has available a large amount of stored energy and as a result can tend to feed in somewhat more power and thereby reduce its state of charge in addition in the direction of the target state of charge.

Otherwise, if the state of charge is comparatively low, the charging station can utilize its latitude in such a way that it tends rather to feed in less power, which, of course, also includes tending rather to take up more power from the grid and store it. As a result, the state of charge is guided in the direction toward the target state of charge.

It should be taken into consideration that it is nevertheless possible that, in the case of a particularly great fall in power that has to be counteracted by the charging station, power is fed into the grid by the charging station even though the state of charge is comparatively low, but is at least below the predefined target state of charge, since complying with the maximum changes is of primary importance.

The underlying insight, however, is that over relatively long operation, that is to say in particular over a day, it is possible to influence the development of the state of charge of the charging station substantially toward the predefined target state of charge. On average statistically, said target state of charge, that is to say, e.g., 50% of full charge, could always be achieved in principle. However, the fluctuations that occur continuously precisely in the case of wind energy installations may prove to be such that the state of charge nevertheless does not tend toward the target state of charge, but rather toward a maximum or minimum state of charge. As one possibility for counteracting that, it is proposed to alter the limiting gradients or at least one of the limiting gradients, that is to say the rise limiting gradient or the decrease limiting gradient.

Preferably, at least one of the limiting gradients is set adaptively. The limiting gradient or the limiting gradients can then in other words be altered during operation, e.g., depending on the state of charge. Therefore, if, e.g., the state of charge is generally very high, namely above the target state of charge, then the rise limiting gradient could be increased or the decrease limiting gradient could be decreased in order that the charging station tends to feed in more stabilizing power compared with the amount of stabilizing power it draws from the grid and stores, to name just one example.

Preferably, the limiting gradient or the limiting gradients is/are set depending on a mean state of charge of the charging station. Therefore, e.g., with the aid of a filter or an integration, over a relatively long period of time such as, e.g., a few hours or a day, the development of the state of charge is observed and averaged in order to obtain a mean state of charge. Depending thereon, the limiting gradients, or at least one of them, can then be set.

To a similar extent, a maximum state of charge that is intended not to be exceeded can preferably also be predefined. The same similarly applies to the predefinition of a predetermined minimum state of charge. The setting can preferably be carried out in such a way that the mean state of charge tends to assume a predetermined charging setpoint value, which can also be referred to as target state of charge.

In this case, the concrete setting of the limiting gradients can be tested beforehand, e.g., in a simulation. Additionally or alternatively, it is also envisaged to change the limit values somewhat gradually, e.g., day by day, and to observe the development of the state of charge of the charging station and then to select a corresponding limiting gradient or corresponding limiting gradients.

In accordance with one embodiment, it is proposed that at least one of the limiting gradients is calculated from a predefined basis limiting gradient multiplied by at least one weighting factor. Here, especially as basis limiting gradient, a limiting gradient, that is to say rise limiting gradient or decrease limiting gradient, can be predefined as limit that must absolutely be complied with. A weighting factor, or the product of a plurality of weighting factors together, can then be selected in such a way that it maximally assumes the value 1. Consequently, the basis limiting gradient would not be exceeded, or not be undershot in the case of a negative value for the decrease limiting gradient. In both cases, therefore, the absolute value would no longer be increased, but rather at most decreased by a factor that is less than 1.

Preferably, at least one of the weighting factors is dependent on the state of charge of the charging station. Additionally or alternatively, at least one of the weighting factors can vary in the range of 0 to 1. In that case, therefore, it cannot increase the basis limiting gradient in terms of absolute value.

Preferably, a further weighting factor can be selected in such a way that it has at least the value 1, in particular is in the range of 1 to 10. Preferably, two weighting factors can be combined, of which one is in the range of 0 to 1 and the other is in the range above 1, in particular in the range of 1 to 10. If these are jointly multiplied by the basis limiting gradient and if said basis limiting gradient is intended not to rise, the selection of these two weighting factors may prove to be such that their product does not become greater than 1.

One embodiment proposes that

the charging station emits electrical power which is fed into the grid together with electrical power of the at least one regenerative energy generator if the electrical power of the regenerative energy generator decreases with a gradient which, in terms of absolute value, is greater than the predefined decrease limiting gradient, or that

the charging station takes up electrical power in order to decrease the electrical power of the at least one regenerative energy generator that is fed into the grid if the electrical power of the regenerative energy generator increases with a gradient which, in terms of absolute value, is greater than the predefined rise limiting gradient.

Accordingly, the charging station emits electrical power if the electrical power of the regenerative generator, in particular of the wind energy installation or of the wind farm, decreases to an excessively great extent or too rapidly. The charging station can thereby take countermeasures. Conversely, it is proposed here that the charging station takes up electrical power if the power of the regenerative energy generator increases to an excessively great extent or too rapidly. In both cases, the feed-in power fed in overall is kept within the desired limits as a result.

Preferably, it is additionally proposed that a time difference between a present second point in time and an earlier first point in time is taken into account for controlling the charging station, and that at the earlier first point in time, as earlier feed-in gradient, account is taken of a gradient of the power which was fed into the grid at the first point in time jointly by the at least one regenerative energy generator and the charging station and, if appropriate, at least one further generator.

For controlling the charging station, therefore, measurements at two points in time are taken as a basis, including the time difference between these points in time. A gradient of the power at a previous point in time is taken as a basis here. In particular, at this earlier point in time, the gradient is used without said time difference being used for this purpose.

Preferably, the power to be emitted or taken up by the charging station at the second point in time is calculated proceeding from these two measurement points in time, the time difference and the earlier feed-in gradient. This is preferably carried out depending on the state of charge of the charging station. For this purpose, it is proposed that this power to be emitted or taken up at the second point in time is calculated from a product composed of

the time difference and

a difference between

the absolute value of the rise limiting gradient and

the earlier feed-in gradient if the charging station has a state of charge that is above a predefined target state of charge, or otherwise from a product of
the negative time difference and
the sum
of the absolute value of the decrease limiting gradient and the earlier feed-in gradient.

Accordingly, the rise limiting gradient is used if the charging station has a comparatively high state of charge, and the decrease limiting gradient is used if the charging station has a comparatively low state of charge, expressed illustratively.

By means of this calculation, the limiting gradients, that is to say rise limiting gradient and decrease limiting gradient, are complied with and, at the same time, the power of the charging station that is to be emitted or taken up is calculated depending on the state of charge of said charging station. At the same time, therefore, insofar as it is permitted by the situation, the development of the state of charge of the charging station is influenced in order to control it as far as possible into a desired range.

Preferably, different measurement locations are also taken as a basis at the different measurement points in time. It is proposed to select a measurement value of a first measurement point at the first point in time and to use a measurement value of a second measurement point at the second point in time. In the course of operation, therefore, measurement is carried out simultaneously at the first and second measurement points or measurement locations, but respectively the measurement value of the first point in time, that is to say the earlier measurement value, is used by the first measurement point and the measurement value of the second point in time, that is to say the present measurement value, is used at the second measurement point. The earlier measurement value and thus the first measurement point relate to the earlier feed-in gradient. The latter is correspondingly measured at the feed-in point into the grid, or at a place in the vicinity via which the same power is transmitted.

At the first measurement point and at the first point in time, in this case the present power emission or uptake of the charging station is measured in order to set, on the basis thereof, the then newly calculated power to be emitted or taken up by the charging station. In this respect, the measurement at the first point in time at the first measurement point particularly influences the concrete setting of the power to be provided by the charging station. Accordingly, it is also proposed that the second measurement point is arranged at the output of the charging station. Such a measurement at different locations at different times may, if appropriate, prevent an instability that could arise as a result of the immediate use of a measurement value in a calculation which directly influences said measurement value.

In accordance with a further embodiment, it is proposed that the power to be emitted or taken up by the charging station is altered by a compensation value depending on a state of charge in order to approximate the present state of charge to a predefined target state of charge. It is thus proposed, independently of the control of the charging station such that the limiting gradients are complied with, to charge or discharge the charging station to a small extent. By way of example, the charging station can be charged with a low power while it is not active at all for control anyway, for example when there is no wind at the wind farm if the latter forms the regenerative generator. It is thereby possible to counteract a situation in which the state of charge moves further and further away from the desired target state of charge. That may also be a phenomenon that occurs for example only on one day.

In accordance with one embodiment, it is proposed that

the charging station feeds electrical power into the grid if the electrical power fed into the grid by the at least one conventional generator increases with a gradient which, in terms of absolute value, is greater than the predefined rise limiting gradient, or that

the charging station takes up electrical power from the grid if the electrical power fed into the grid by the at least one conventional generator decreases with a gradient which, in terms of absolute value, is greater than the predefined decrease limiting gradient.

This embodiment is proposed especially for the case when the at least one conventional generator and the charging station do not feed into the grid via a common feed-in point. In other words, the charging station feeds into the grid in such a way that it compensates for at least a portion of the power fluctuations in the grid in such a way that a demand for an excessively great power change no longer arises for the conventional generator.

One embodiment proposes that the at least one regenerative generator, in particular the wind energy installation,

momentarily increases its fed-in power above the power maximally available from the wind at the moment,

momentarily increases its fed-in power above the instantaneously fed-in power,

momentarily decreases its fed-in power below the power maximally available from the wind at the moment, or

momentarily decreases its fed-in power below the instantaneously fed-in power,

in order thereby to decrease power spikes to be compensated for by the charging station or by the at least one conventional generator.

Provided is an advantageous limiting of power changes of fed-in power by corresponding control of a charging station. It has been recognized, however, that this can be associated synergistically with a control of the regenerative generator, in particular with a control of one or a plurality of wind energy installations. Regenerative generators, in particular wind energy installations, preferably generate as much power as is possible on the basis of the present conditions. A wind energy installation therefore generates as far as possible as much power as can be drawn from the wind at the present moment. Resultant fluctuations can be limited by the use of the charging station. Nevertheless it may be helpful also to use the wind energy installation for control. Particularly if the charging station has an inexpedient state of charge, it can be helpful for the control to be momentarily taken over or supplemented by the wind energy installation. In this case, the wind energy installation can increase or decrease its power. It can increase or decrease the power above or below the present value or, alternatively, increase or decrease the power above or below the available power from the wind. Such an increase is possible at particularly short notice by the use of kinetic energy of the rotor of the wind energy installation.

As a result, what can also be achieved, inter alia, is that the charging station is implemented smaller and more cost-effectively. A charging station can be dimensioned in such a way that it can fulfil its task for example on 95% of all days in the year. In order to cover this last 5% of the days in the year as well, it would have to be designed possibly to be significantly larger. It would be unnecessary if the wind energy installation or installations as an exception take(s) over or supplement(s) the task of the charging station in this case.

Provided is an electrical supply grid, which can also be referred to simply as electrical grid. In particular, an electrical island grid is proposed. This grid is prepared to be operated by a method according to any of the above embodiments.

Provided is a charging station prepared to be operated in the proposed grid.

Also provided is a wind energy installation prepared to be operated in said electrical grid.

Also provided is a wind farm prepared to be used as a regenerative generator in an electrical grid as described above.

### BRIEF DESCRIPTION OF THE SEVERAL VIEWS OF THE DRAWINGS

The invention is explained in greater detail by way of example below on the basis of exemplary embodiments with reference to the accompanying figures.

FIG. 1 shows a wind energy installation schematically in a perspective illustration.

FIG. 2 shows a wind farm comprising a plurality of wind energy installations in a schematic illustration.

FIG. 3 shows an electrical grid comprising a wind energy installation, a charging station, a conventional generator and loads in accordance with a first configuration.

FIGS. 4 to 9 illustrate the control of a charging station in accordance with one embodiment and for the configuration in accordance with FIG. 3 for different states or boundary conditions with respect to predefined limiting gradients.

FIG. 10 shows the temporal profile of some powers for different parameterizations of the control of the charging station.

FIG. 11 shows the temporal profile of a state of charge of the controlled charging station in each case in regard to the control taken as a basis in FIG. 10.

FIG. 12 shows an electrical grid comprising a wind energy installation, a charging station, a conventional generator and loads in accordance with a second configuration.

### DETAILED DESCRIPTION

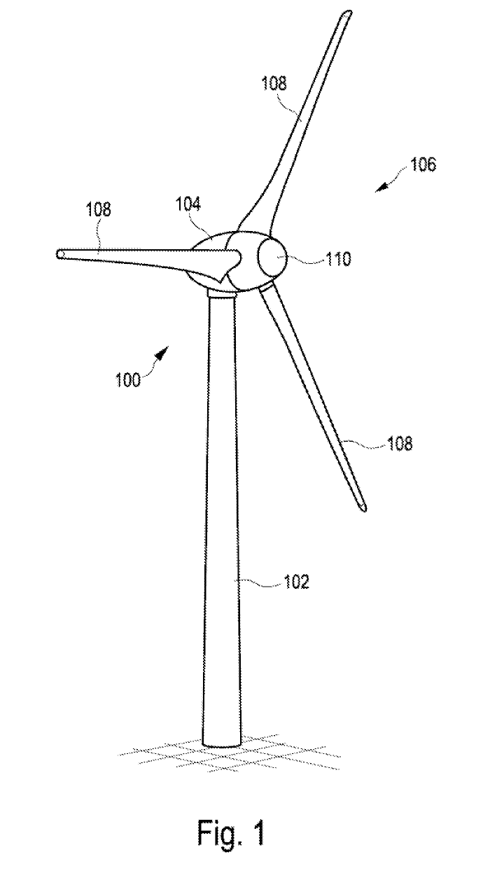

FIG. 1 shows a wind energy installation 100 comprising a tower 102 and a nacelle 104. A rotor 106 comprising three rotor blades 108 and a spinner 110 is arranged on the nacelle 104. The rotor 106 is caused to effect rotational motion by the wind during operation and thereby drives a generator in the nacelle 104.

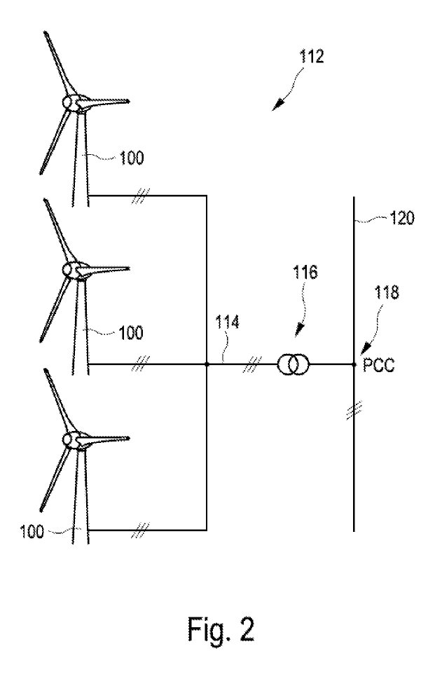

FIG. 2 shows a wind farm 112 comprising for example three wind energy installations 100, which can be identical or different. The three wind energy installations 100 are therefore representative of fundamentally any desired number of wind energy installations of a wind farm 112. The wind energy installations 100 provide their power, namely in particular the generated current, via an electrical farm grid 114. In this case, the respectively generated currents or powers of the individual wind energy installations 100 are added and a transformer 116 is usually provided, which steps up the voltage in the farm in order then to feed it into the supply grid 120 at the feed-in point 118, which is also generally designated as PCC. FIG. 2 is merely a simplified illustration of a wind farm 112 showing no control, for example, even though a control is present, of course. Moreover, by way of example, the farm grid 114 can be designed differently, for example by a transformer also being present therein at the output of each wind energy installation 100, to mention just one other exemplary embodiment.

Provided is a strategy for charging and discharging an energy store coupled to a grid, which strategy makes it possible to limit power gradients which can arise for example as a result of renewable energy generators such as wind energy installations or photovoltaic installations, for example.

The energy store is also designated here as charging station or simply as battery. In this case, however, the energy store or the charging station can comprise control for controlling the charging and discharging.

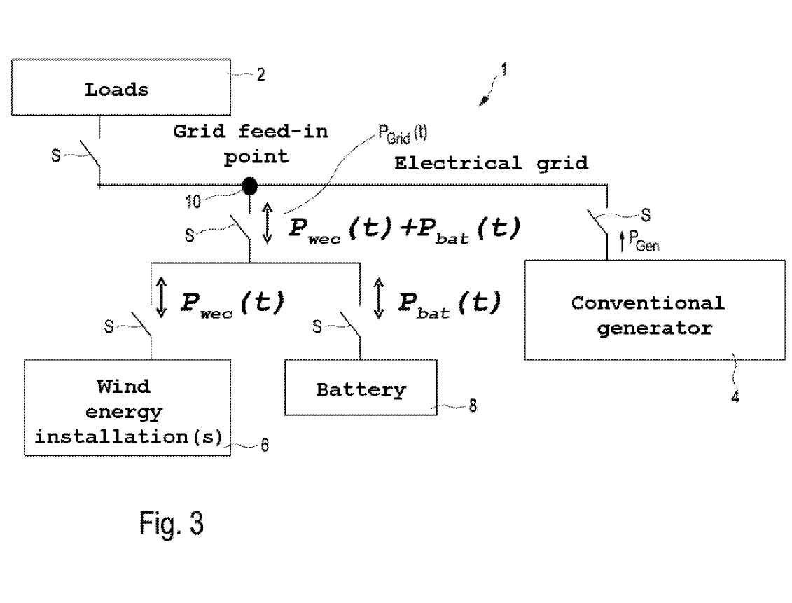

Various grid configurations can be taken as a basis, which can be characterized by the interconnection of the wind energy installation, the charging station or battery and the conventional generator. A grid configuration illustrated in FIG. 3 is taken as a basis below for exemplary explanation.

An electrical supply grid 1 which is intended to supply loads 2 with electric current is illustrated schematically in accordance with FIG. 3. As energy generator, a conventional generator 4 is connected to the grid 1. Moreover, at least one wind energy installation 6 and a charging station 8 are connected to the grid via a grid feed-in point 10. All of the schematically illustrated parts of the grid 1, namely loads 2, conventional generator 4, wind energy installation 6 and charging station 8, can also in each case comprise a plurality of such elements of their type or be representative thereof. In particular, the wind energy installation 6 is also representative of a wind farm 6.

The wind energy installation 6 provides a power P_{wec}(t) and the charging station 8, which can also be referred to as battery 8 for simplification, provides a power P_{bat}(t). These powers can thus vary over time and their sum is fed into the grid 1 at the grid feed-in point 10. Both the power of the wind energy installation P_{wec}(t) and the power of the charging station P_{bat}(t) can both be fed into the grid and be drawn from the grid. In the case of being drawn from the grid, that means for the power P_{bat}(t) of the charging station 8 that the charging station or a battery in the charging station is charged thereby. The wind energy installation 6 substantially feeds power in but, via chopper resistors or buffer stores, for example, could also tap off and thereby consume power from the grid or buffer-store it, if this is necessary or helpful for grid support. Moreover, FIG. 3 symbolically illustrates various switches S that can isolate the respective element from the grid.

In the case of this configuration in accordance with FIG. 3, a feed-in power fed into the grid 1 is the sum of the power P_{wec} of the wind energy installation 6 and the power P_{bat} of the charging station 8. This sum can also be designated as P_{grid}. That is therefore the power which is fed into the grid, or is drawn from there in the case of a negative sign, at the grid feed-in point 10. The conventional generator 4 also feeds in power, but the latter is not mentioned in the consideration on which FIG. 3 is based.

Optionally, the wind energy installation 6 and the charging station 8 could be assigned a further conventional generator, the power of which would then also be part of the feed-in power P_{grid} fed in at the grid feed-in point 10. Such a conventional generator, that is to say in particular diesel generator, could be supplementarily connected, e.g., if the wind were not very strong, to give just one example.

In the case of this configuration, it is then proposed that the feed-in power P_{grid} is limited in terms of its change over time. It is therefore proposed that at the grid feed-in point 10 power changes and thus power gradients of the power fed in there are kept within limits. That can be carried out by means of a corresponding control of the charging station 8.

In accordance with FIG. 3, one or a plurality of wind energy installations 6 and the battery system 8, which can also be referred to as charging station, feed into an electrical grid 1 via a common grid feed-in point 10, said electrical grid additionally comprising a conventional generator 4 and various loads.

A power gradient

$${\frac{Δ P}{Δ t} \vert}_{grid} ( t )$$

at the point in time t which is fed in at the grid feed-in point 10 can be defined as follows:

$${\frac{Δ P}{Δ t} \vert}_{grid} ( t ) = \frac{{P}_{WEC} ( t 2 ) - {P}_{grid} ( t 1 )}{Δ t} \qquad [ 1 ]$$

wherein P_{wec}(t2) is the wind farm power measured at the point in time t₂, and P_{grid}(t1) is the feed-in power measured at the grid feed-in point at the point in time t₁. In this case, t₂ is the present point in time succeeding t₁. Δt is the time step chosen for determining the power gradients and results from the difference between t₂ and t₁.

If the active power gradient fed in at the grid feed-in point is intended to be limited to a maximum and respectively minimum limit value

$${{( \frac{Δ P}{Δ t} \vert}_{lim}^{down} , \frac{Δ P}{Δ t} \vert}_{lim}^{up} )$$

or be kept within such limit values, then a specific active power (P_{bat}) must be fed to the grid or drawn from the grid, depending on the type (positive or negative) and absolute value of the gradient (above or below the limit value). For such a power, it is proposed that the latter can be taken up or emitted by an energy storage system, which in this application is designated synonymously as charging station 8 and, e.g., can be embodied as a battery or can comprise a battery.

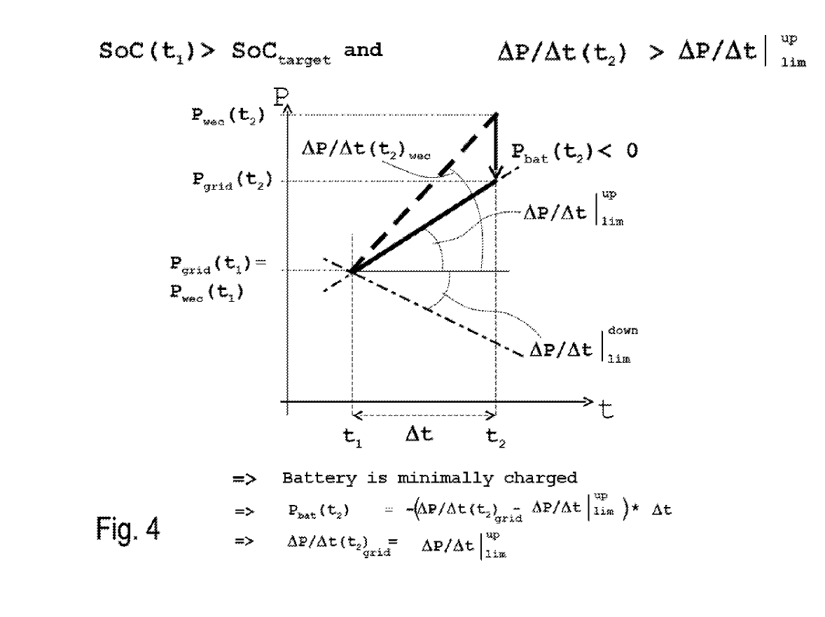

FIG. 4 illustrates both the wind energy installation power P_{wec} and the power at the grid feed-in point P_{grid} at the successive points in time t₁ and t₂. In this case, P_{grid} is composed additively of P_{wec} and P_{bat}.

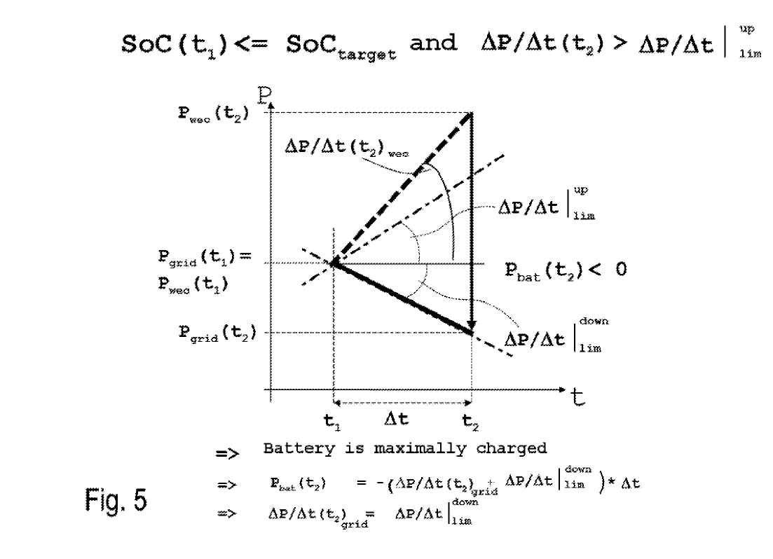

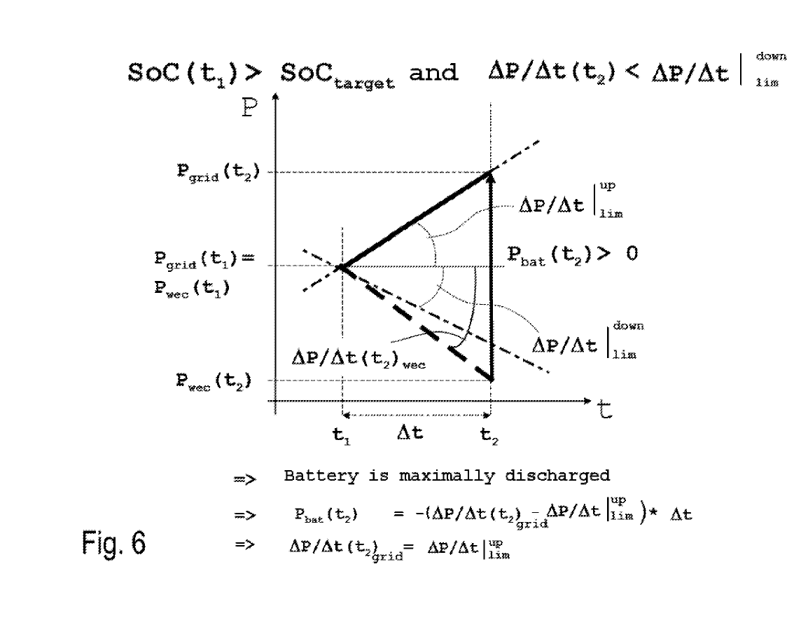

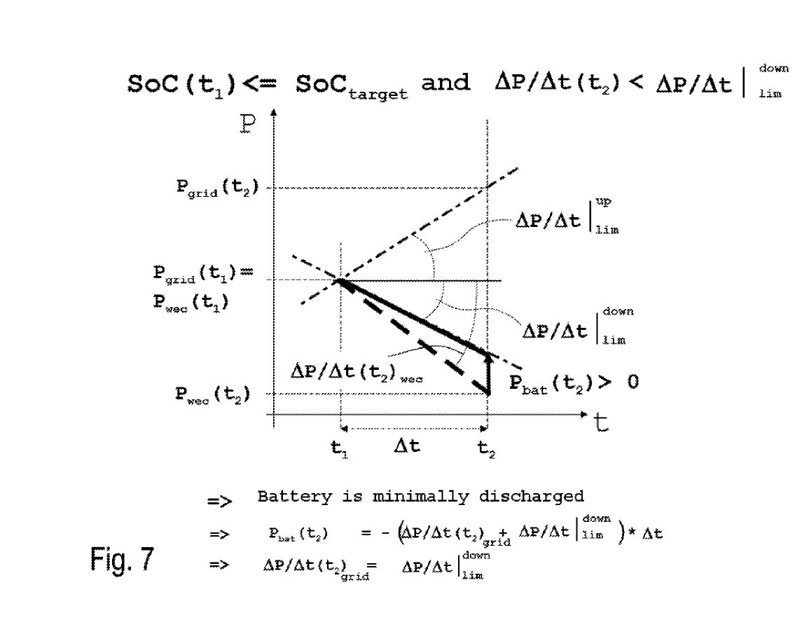

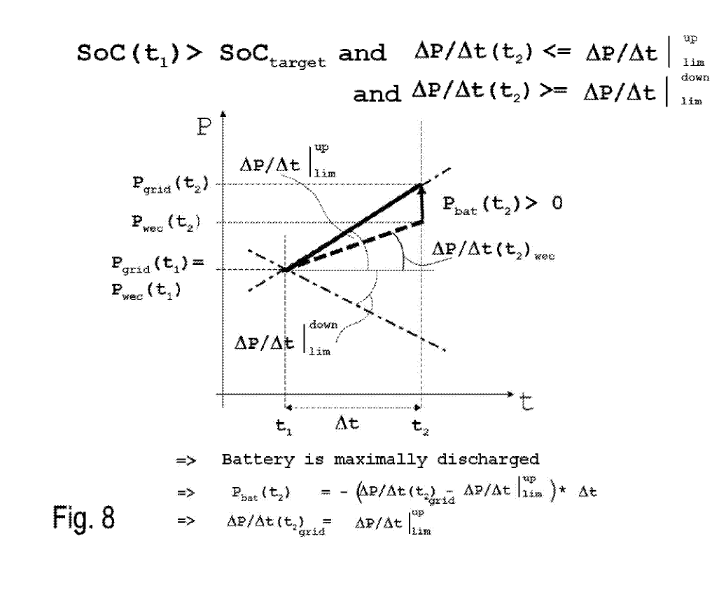

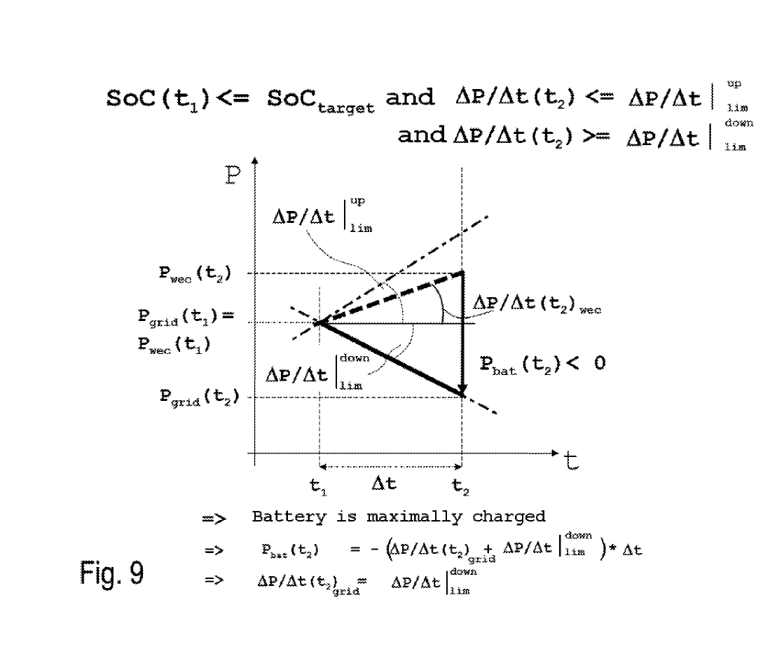

The power P_{grid}(t1) at the grid feed-in point and the wind energy installation power P_{wec}(t1) are assumed to be identical at the point in time t₁ in said FIG. 4 and also in FIGS. 5 to 9. The wind energy installation power P_{wec}(t2) shall be manifested at the point in time t₂. From Equation [1], the power gradient

$$\frac{Δ P}{Δ t} \vert ( t 2 )$$

then results, which in the example in accordance with FIG. 4 is greater than the upper limit value

$${\frac{Δ P}{Δ t} \vert}_{lim}^{up} ,$$

which is given as an upper limit value, namely as a rise limiting gradient.

In order to ensure a power gradient of

$${\frac{Δ P}{Δ t} \vert}_{lim}^{up}$$

at the grid feed-in point, the battery must take up the power P_{bat}(t2) at the point in time t₂. Said power is negative in the case described and is calculated as

$${{P}_{bat} ( t ) = {( \frac{Δ P}{Δ t} \vert}_{lim}^{up} - \frac{Δ P}{Δ t} \vert}_{grid} ( t ) ) \cdot Δ t ; \qquad [ 2 ]$$

The capacity of an energy store which allows the battery power P_{bat} to be provided is limited. The availability of the battery power P_{bat} is dependent on the state of charge of the battery, this being designated as SoC. If the store is uncharged (SoC=0%), no additional power can be fed in. If the store is completely charged (SoC=100%), no additional power can be taken up.

Therefore, it is proposed to operate the store during operation with a state of charge SoC that is as constant as possible between the two extreme states of charge. Such a target state of charge can be predefined as a setpoint value SoC_{target}. In order that the temporal profile of the state of charge SoC deviates as little as possible from the setpoint state of charge SoC_{target}, it is proposed that charging and discharging powers correspond to one another on average over time.

It has been recognized that the absolute value of the limiting gradients

$${{\frac{Δ P}{Δ t} \vert}_{lim}^{down} and \frac{Δ P}{Δ t} \vert}_{lim}^{up} ,$$

which can be predefined as decrease limiting gradient

$${\frac{Δ P}{Δ t} \vert}_{lim}^{down}$$

and rise limiting gradient

$${\frac{Δ P}{Δ t} \vert}_{lim}^{up} ,$$

respectively, has me following influence on battery operation:

It affects the probability of battery charging or discharging

It affects the power to be provided or taken up by the battery

It is proposed, then, to influence the state of charge of the battery by corresponding selection of the limiting gradients.

That is to say that a lower or upper limit value

$${{( \frac{Δ P}{Δ t} \vert}_{lim}^{down} or \frac{Δ P}{Δ t} \vert}_{lim}^{up} )$$

of a power gradient is selected depending on the difference between the state of charge SoC and the setpoint state of charge SoC_{target}. As a result, it is possible to control whether the battery is charged with a maximum/minimum power or is discharged with a maximum/minimum power.

FIGS. 4 to 9 illustrate for three exemplary situations of a power gradient

$$\frac{Δ P}{Δ t} \vert ( t ) ,$$

namely for the feed-in power P_{grid}, resulting battery powers P_{bat}(t) that are achieved by means of the proposed method. The basic type of illustration has already been explained in part above with regard to FIG. 4 and is also analogously applicable to the other FIGS. 5 to 9.

These three exemplary situations are also representative, in principle, of three possible situations of the power gradient and they are:

1. The power gradient

$$\frac{Δ P}{Δ t} \vert ( t )$$

is greater than the upper limiting gradient

$$\frac{Δ P}{Δ t} {\vert}_{lim}^{up}$$

2. The power gradient

$$\frac{Δ P}{Δ t} \vert ( t )$$

is less than lower limiting gradient

$$\frac{Δ P}{Δ t} {\vert}_{lim}^{down}$$

3. The power gradient

$$\frac{Δ P}{Δ t} \vert ( t )$$

is less than the upper limiting gradient

$$\frac{Δ P}{Δ t} {\vert}_{lim}^{up}$$

and greater than the lower limiting gradient

$$\frac{Δ P}{Δ t} {\vert}_{lim}^{down}$$

The upper limiting gradient

$$\frac{Δ P}{Δ t} {\vert}_{lim}^{up}$$

is also designated synonymously as the rise limiting gradient, and the lower limiting gradient

$$\frac{Δ P}{Δ t} {\vert}_{lim}^{down}$$

is synonymously also designated as the decrease limiting gradient.

In addition to the abovementioned possible situations of the power gradient, the state of charge of the charging station or of its battery or batteries has an influence. For explanation purposes, reference will also simply be made to the battery, for simplification. The state of charge is designated as SoC in the figures and considered in relation to a target state of charge, designated therein as SoC_{target}.

The battery can be in the following two states of charge:

1. SoC>SoC_{target}

2. SoC<=SoC_{target}

The theoretical state that the state of charge corresponds exactly to the target charge (SoC=SoC_{target}) has been assigned here to the second variant, this not being essential.

It is thus possible to combine six possible cases with regard to the power gradient and state of charge, which are shown in Table 1 and FIGS. 4 to 9.

Table 1 indicates for these six cases the equations in accordance with one embodiment by means of which the battery power P_{bat}(t) is determined in order to cause the state of charge SoC to converge as much as possible toward the target state of charge SoC_{target}. The table also indicates the figures which show the corresponding power gradients for these six different cases.

The cases shown in Table 1 can be summarized such that the power P_{bat}(t) to be provided by the battery can be calculated as follows:

$$\begin{matrix}{P}_{bat} ( t ) = - ( \frac{Δ P}{Δ t} {\vert}_{lim}^{down} + \frac{Δ P}{Δ t} {\vert}_{grid} ( t ) ) \cdot Δ t ; for {SOC}_{bat} ( t ) < {SOC}_{target} & [ 3 ] \\ {P}_{bat} ( t ) = ( \frac{Δ P}{Δ t} {\vert}_{lim}^{up} \frac{Δ P}{Δ t} {\vert}_{grid} ( t ) ) \cdot Δ t ; for {SOC}_{bat} ( t ) \geq {SOC}_{target} & [ 4 ]\end{matrix}$$

The temporal deviation of the battery state of charge SoC (t) around the target value SoC_{target} depends on how the wind power changes, which leads to unforeseeable power changes and thus power gradients. In other words, said temporal deviation depends on a stochastic sequence of negative or positive power gradients. The latter are intended to be limited by the battery operation. The more often negative gradients are compensated for, the more likely the store will be drained, and vice versa.

FIGS. 4 to 9 reveal that the charging station is controlled in such a way that a gradient of the feed-in power is brought to a range which is defined by the rise limiting gradient and the decrease limiting gradient. In this case, an attempt is made to change the gradient either to the rise limiting gradient or to the decrease limiting gradient. The decision between them depends on the state of charge. If the latter is above its target value, the rise limiting gradient is selected, otherwise the decrease limiting gradient is selected.

It is furthermore proposed to approximate the feed-in power P_{grid} to the time-averaged power profile of the wind farm [symbol] This can be achieved if the battery is charged or discharged with an average power [symbol] (ξ). This power can be superposed on the dynamic power emitted or taken up by the battery in accordance with FIGS. 4 to 9. It is proportional to the difference between [symbol] and P_{grid} and it can be set as follows by means of the use of a weighting F:

[symbol]

(t)=( [symbol] (t2)−P_{grid}(t1))·F [5]

The weighting F is thus a suitable proportionality factor to be selected.

In order both to ensure compliance with limiting power gradients with the aid of the battery, particularly as described in association with FIGS. 4 to 9, and at the same time to ensure operation of the storage medium with a stable state of charge, it is proposed to predefine for the storage medium a setpoint power P_{bat}_{_}ₜₒₜₐₗ(t), which results from the superposition of P_{bat}(t) and [symbol] as follows:

P_{bat}_{_}ₐₘₒᵤₙₜ(t)=P_{bat}(t)+ [symbol] (t) [6]

In order to improve the feed-in behavior of the wind energy installation together with the battery, it is also proposed to adapt the limiting gradients

$$\frac{Δ P}{Δ t} {\vert}_{lim}^{down} and \frac{Δ P}{Δ t} {\vert}_{lim}^{up}$$

in Equations [3] and [4] depending on the state of charge SoC. It has been recognized that the state of charge, in particular the mean state of charge, can thereby be influenced, at any rate at least if the charging station is controlled in the manner as described with regard to FIGS. 4 to 9.

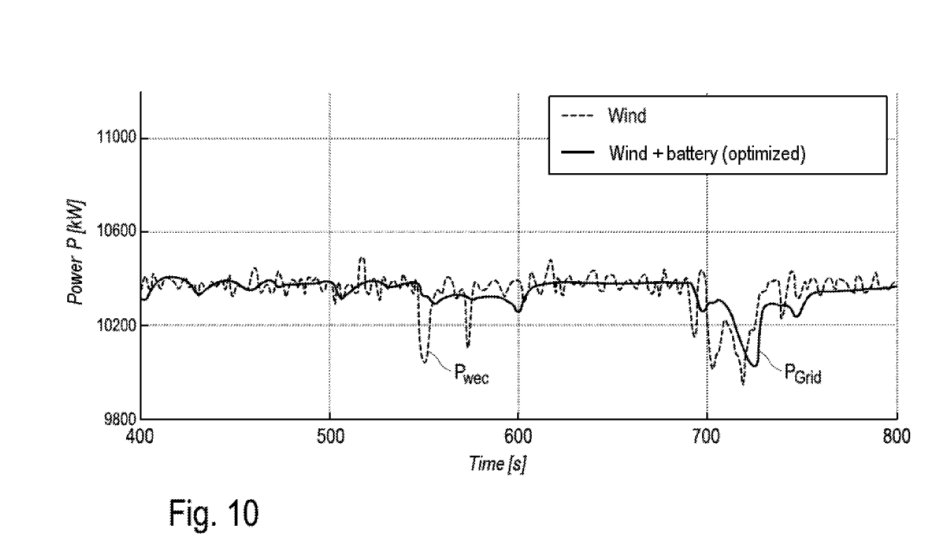

FIG. 10 shows by way of example for the configuration in accordance with FIG. 3 two temporal power profiles, namely of the power P_{wec} of the at least one wind energy installation and of the total feed-in power P_{Grid} of wind energy installation and charging station or battery jointly. In principle, two parameterizations are taken into consideration. The first parameterization sets the abovementioned weighting factor F to zero and two identical and constant values for the rise limiting gradient and the decrease limiting gradient are also taken as a basis. This configuration is defined mathematically below as “parameterization 1”.

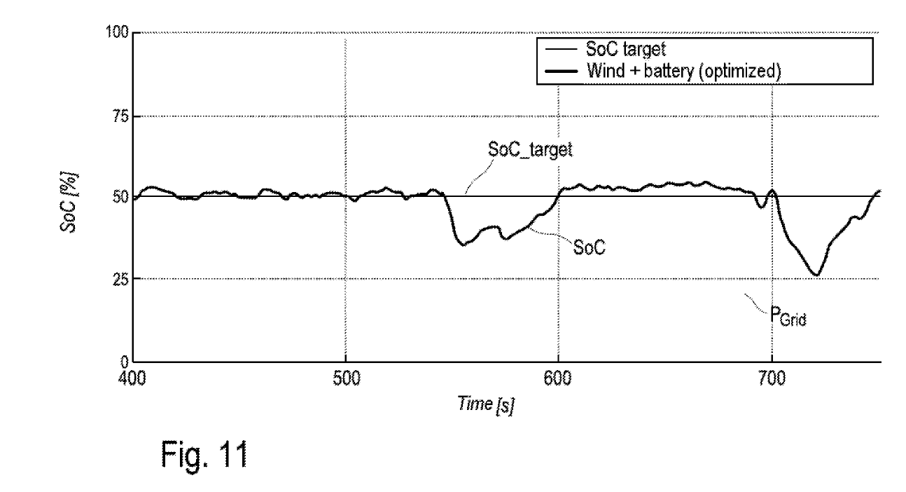

Preferably, however, a parameterization designated as “parameterization 2” is used, which is designated as “wind+battery (optimized)” for simplification in FIGS. 10 and 11. In this preferred embodiment, the weighting factor F is not set to zero and different and variable values for the rise limiting gradient and the decrease limiting gradient are taken as a basis. FIGS. 10 and 11 show results only for this second parameterization.

FIG. 11 shows the profile of the state of charge of the battery for the second configuration of the control of the power feed-in. In the illustration, a target state of charge of 50% is depicted and designated as “SoC target”.

Parameterization 1:

Wind+battery: F=0 (Equation [5]) and

$$\frac{Δ P}{Δ t} {\vert}_{lim}^{down} , \frac{Δ P}{Δ t} {\vert}_{lim}^{up} = constant$$

Parameterization 2:

Wind+battery (optimized): F≠0 (Equation [5]) and

$$\frac{Δ P}{Δ t} {\vert}_{lim}^{down} , \frac{Δ P}{Δ t} {\vert}_{lim}^{up} = variable$$

F in the second parameterization is thus variable over time and dependent on:
the instantaneous state of charge SoC,
the target state of charge “SoC target” and/or
the time-averaged power profile of the wind farm

[symbol]

The dimensionless, positive factor F varies between the values 0 and 1 (or greater) over time, depending on the application. The greater the difference between the present state of charge SoC and the target state of charge SoC_target, the greater, at any rate in accordance with one preferred embodiment, the factor F is chosen to be. In this case, the factor F is altered or set depending on the state of charge.

$$\frac{Δ P}{Δ t} {\vert}_{lim}^{down} , \frac{Δ P}{Δ t} {\vert}_{lim}^{up}$$

in the case of parameterization 2 is likewise variable over time and dependent on the difference between the present state of charge SoC and the target state of charge SoC_target.

The result in FIG. 10 shows that the proposed control of the charging station 8, namely a control on the basis of the parameterization 2, makes it possible to achieve a greatly stabilized feed-in power in comparison with the feed-in of the wind energy installation without a battery.

FIG. 11 shows the associated profile of the state of charge SoC with respect to the profile of the total feed-in power P Grid from wind energy installation and charging station together in accordance with FIG. 10. FIG. 11 reveals that the parameterization 2, that is to say the preferably proposed control, makes it possible to operate the battery with a comparatively stable state of charge. If the state of charge of the battery falls owing to a momentary dip in the wind energy installation power, which is the case for instance at ≈550 s, the state of charge converges toward its target value SoC_{target} again after a short time.

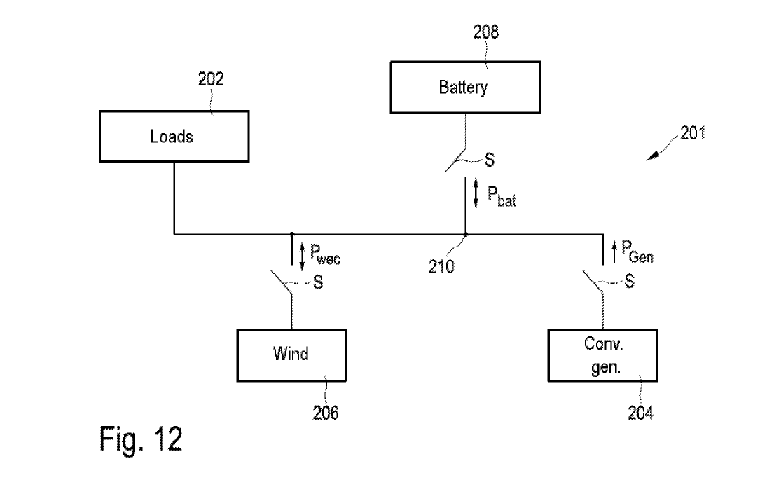

FIG. 12 shows, in contrast to FIG. 3, a second configuration of an underlying or considered grid 201. This grid 201 basically also comprises the elements or participants explained in FIG. 3, namely loads 202, a wind energy installation 206, which can also be representative of a wind farm, a battery 208, which here is also representative of the charging station, and at least one conventional generator 204.

For this configuration, it is proposed, then, to control the charging station 208 or battery 208 in such a way that the power P_{Gen} fed into the grid by the generator 204 is limited in terms of its change over time. This power P_{Gen} fed into the grid by the generator forms in this respect the feed-in power that is limited in terms of its change over time. Here the consideration taken as a basis, then, is that fluctuations in the load 202 and also fluctuations in the fed-in power P_{wec} of the wind energy installation 206 without a charging station 208 or battery 208 would have the effect that these fluctuations would have to be compensated for by the power P_{Gen} in by the generator. If these changes over time are too great, the conventional generator has to change its load too rapidly or, in the case of generator banks, that would mean that generators must be supplementarily connected or disconnected too rapidly. Particularly for motors based on fossil fuels, that is to say in particular diesel motors, that is very inexpedient for their lifetime. The charging station or battery 208 is intended to compensate for that. For this purpose, the change of the feed-in power P_{Gen} is detected and the charging station or battery 208 is controlled accordingly.

If the loads 202 substantially tap off their power in a constant manner, this configuration and corresponding control of the battery 208 or charging station 208 can lead to results very similar to those in the case of the configuration in accordance with FIG. 3. This is because in this case the power fluctuations mentioned arise merely as a result of power fluctuations of the wind energy installation 206. Therefore, in this case, too, the battery 208 or charging station 208 would prevent an excessively great power change of the wind energy installation 206.

For the case where the loads also fluctuate, however, the battery 208 will detect and take account of the total power fluctuation arising as a result of the loads 202 and the wind energy installation 206.

For further details, reference is then made to the text above, to the parts of the general description which describe features and embodiments concerning this second configuration.

1. A method for operating an electrical charging station at an electrical grid comprising, alongside electrical loads, at least one regenerative energy generator, at least one conventional generator operated by fossil fuels, and at least the electrical charging station for storing and re-emitting electrical power, the method comprising:
generating electrical power by means of the at least one regenerative energy generator and feeding the electrical power into the grid,
storing electrical power not consumed by the loads in the charging station,
feeding electrical power into the grid by means of the charging station when the loads consume more power than is fed into the grid jointly by the at least one regenerative generator and the at least one conventional generator, wherein:
in a first configuration of the grid, a feed-in power fed into the grid is a sum of:
a power of the at least one regenerative energy generator, and
a power of the charging station
in a second configuration of the grid, the feed-in power fed into the grid is the power generated by the at least one conventional generator,
and wherein the charging station is controlled in such a way that the feed-in power is limited in terms of its change over time.

2. The method according to claim 1, wherein, for limiting the change over time of the feed-in power, at least one limiting gradient is predefined, from the list comprising:
a rise limiting gradient, which determines with what change per time the feed-in power is intended maximally to increase, and
a decrease limiting gradient, which determines with what change per time the feed-in power is intended maximally to decrease.

3. The method according to claim 2, characterized in that wherein the rise limiting gradient and the decrease limiting gradient differ from one another in terms of absolute value.

4. The method according to claim 1, wherein the charging station is controlled in such a way that the change of the feed-in power is guided within a positive and negative limit or within the rise limiting gradient and the decrease limiting gradient and that for the case of the first configuration:
the change of the feed-in power is positive when the charging station has a state of charge that is above a predefined target state of charge, or
the change of the feed-in power is negative when the charging station has a state of charge that is below a predefined target state of charge, and
that for the case of the second configuration:
the change of the feed-in power is negative when the charging station has a state of charge that is above a predefined target state of charge, or
the change of the feed-in power is positive when the charging station has a state of charge that is below a predefined target state of charge.

5. The method according to claim 1, wherein at least one of the limiting gradients:
is set adaptively,
is set depending on a mean state of charge of the charging station
is set in such a way that the charging station does not fall below a predetermined minimum state of charge,
is set in such a way that the charging station does not exceed a predetermined maximum state of charge, and/or
is set in such a way that a mean state of charge of the charging station assumes a predetermined charging setpoint value.

6. The method according to claim 1, wherein at least one of the limiting gradients is calculated from a predefined basis limiting gradient multiplied by at least one weighting factor.

7. The method according to claim 6, wherein:
at least one of the weighting factors is dependent on a state of charge of the charging station,
at least one of the weighting factors can vary in the range of 0 to 1,
at least one of the weighting factors has a value of a range of 1 to 10, and/or
at least two weighting factors are used for the calculation of a respective limiting gradient.

8. The method according to claim 1, wherein for the case of the first configuration:
the charging station emits electrical power which is fed into the grid together with electrical power of the at least one regenerative energy generator when the electrical power of the at least one regenerative energy generator decreases with a gradient which, in terms of absolute value, is greater than the predefined decrease limiting gradient, or
the charging station takes up electrical power in order to decrease the electrical power of the at least one regenerative energy generator that is fed into the grid if when the electrical power of the at least one regenerative energy generator increases with a gradient which, in terms of absolute value, is greater than the predefined rise limiting gradient.

9. The method according to claim 1, wherein:
a time difference between a present second point in time and an earlier first point in time is taken into account for controlling the charging station, and
at the earlier first point in time, as earlier feed-in gradient, account is taken of a gradient of the power which was fed into the grid at the first point in time jointly by the at least one regenerative energy generator and the charging station.

10. The method according to claim 9, wherein for the case of the first configuration:
the power to be emitted or taken up by the charging station at the second point in time is calculated from a product of:
the time difference, and
a difference between -the absolute value of the rise limiting gradient and the earlier feed-in gradient when the charging station has a state of charge that is above a predefined target state of charge, or
a product of:
the negative time difference, and
the sum of the absolute value of the decrease limiting gradient and the earlier feed-in gradient.

11. The method according to claim 9, wherein a measurement value of a first measurement point is used at the first point in time and a measurement value of a second measurement point is used at the second point in time.

12. The method according to claim 1, wherein the power to be emitted or taken up by the charging station is altered by a compensation value depending on a state of charge in order to approximate the present state of charge to a predefined target state of charge.

13. The method according to claim 1, wherein for the case of the second configuration:
the charging station emits electrical power to the grid when the electrical power fed into the grid by the at least one conventional generator increases with a gradient which, in terms of absolute value, is greater than the predefined rise limiting gradient, or
the charging station takes up electrical power from the grid when the electrical power fed into the grid by the at least one conventional generator decreases with a gradient which, in terms of absolute value, is greater than the predefined decrease limiting gradient.

14. The method according to claim 1, wherein:
a time difference between a present second point in time and an earlier first point in time is taken into account for controlling the charging station, and
at the earlier first point in time, as earlier feed-in gradient, account is taken of a gradient of the power which is fed into the grid at the first point in time by the at least one conventional generator.

15. The method according to claim 1, wherein the at least one regenerative generator:
momentarily increases its fed-in power above the power maximally available from the wind at the moment,
momentarily increases its fed-in power above the instantaneously fed-in power,
momentarily decreases its fed-in power below the power maximally available from the wind at the moment, or
momentarily decreases its fed-in power below the instantaneously fed-in power, in order thereby to decrease power spikes to be compensated for by the charging station or by the at least one conventional generator.

16. An electrical grid prepared to be operated by a method according to claim 1.

17. A charging station prepared for use in a grid according to claim 16.

18. A wind energy installation, prepared for use in an electrical grid according to claim 16.

19. A wind farm prepared for use as a regenerative energy generator in an electrical grid according to claim 16.

20. The method according to claim 1, wherein the at least one regenerative energy generator is a generator of a wind energy installation and is controlled in such a way that the feed-in power is limited in terms of its change over time.

21. The method according to claim 1, wherein in the first configuration of the grid, the sum of the feed-in power fed into the grid further includes a power of at least one further generator of the charging station.
